(19) United States
(12) Patent Application Publication
(10) Pub. No.: US 2010/0025189 A1
(43) Pub. Date: Feb. 4, 2010

(54) METHOD AND DEVICE FOR UNIFYING IMBRICATED FLOWS

(75) Inventor: Erwin Muller, Durnten (CH)

Correspondence Address: RANKIN, HILL & CLARK LLP, 38210 Glenn Avenue, WILLOUGHBY, OH, 44094-7808, US

(73) Assignee: FERAG AG, Hinwil (CH)

(21) Appl. No.: 12/523,966

(22) PCT Filed: Oct. 23, 2007
(86) PCT No.: PCT/CH2007/000527

§ 371 Date: Sep. 21, 2009

(30) Foreign Application Priority Data
Jan. 22, 2007 (CH) 87/07

(51) Int. Cl. B65H 39/06; B65H 29/66; B65G 37/00; B65G 47/30; B41F 21/00

(52) U.S. Cl. 198/418.1; 198/448; 198/617; 270/18

(57) ABSTRACT

A method and a device are provided for combining overlapping flows (S1, S2) of flat products (10, 20), particularly of printed products, to common product flows (P3). The products (10, 20) from the first or second overlapping flows (S1, S2) are received by an intermediate conveyor (50), and transported to a first product flow (P1), or a second product flow (P2), by means of the intermediate conveyor (50). The distance (d) of the product flows (P1, P2) is successively reduced so that the product flows (P1, P2) form the common product flow (P3). The products (10, 20) are conveyed at least directly before combining the product flows (P1, P2) such that a space (12, 22) is located at least between the groups of products (10, 20) within the first, or within the second product flow (P1, P2). The products (10, 20) of at least one of the product flows (P1, P2) are displaced in a direction extending substantially perpendicular to the surface normal (14, 24) relative to the products (10, 20) of the other product flow (P1, P2).

### BACKGROUND OF THE INVENTION

1. Field of the Invention

The invention lies in the field of conveyor technology for flat products, in particular printed products, and relates to a method for unifying at least one first imbricated flow and a second imbricated flow distanced thereto, as well as to a device for carrying out the method.

2. Description of Related Art

It is particularly in the field of processing printed products that the task of leading together imbricated flows of flat products into a common product flow often occurs, wherein the original flows are separate from one another. The common product flow may either be an imbricated flow, but may also designed differently, e.g. a flow of products gripped individually or in groups by grippers, or one or more stacks of several products. For example, some rotation printing machines feed printed products in pairs folded into one another with a lateral offset, into an imbricated formation. Two separate imbricated flows are produced by way of this imbricated formation being pulled apart in the offset direction, i.e. transverse to the conveying direction. For further processing, it is desirable to lead these separate imbricated flows together again into a common product flow.

Flat products are to be understood as those products whose thickness is significantly smaller than their length and width. If one speaks of a surface normal of the products, this is meant as the surface normal of the front surface or rear surface, i.e. the surface normal in the direction of the thickness or the smallest dimension of the product. As a rule, the conveying in a spatially compact formation is desired, with which the distances of the products, e.g. the distances of the leading edges at any point in time, is significantly smaller than the length or width of the products.

The state of the art already discloses two different methods or devices for unifying two imbricated flows.

EP-B 0 155 633, for example, suggests the unification of two imbricated flows conveyed in a lying manner, in the manner of a zip closure. The imbricated flows are conveyed to one another with an offset of half the product length at an acute angle. The products lie, i.e. their surface normals point essentially in the vertical direction. In each case, a product of one of the imbricated flows is deflected in regions upwards out of the common transport plane at the location of where they meet, so that in each case a product from the other imbricated flow may move in. The two imbricated flows mesh into one another in the manner of a zip closure in this manner, and are then pushed together transversely to the transport device. Since the running-in imbricated formations are not broken up, here it may occur that the products are compressed or even creased due to the friction, particularly if these are thin or still moist from the printing.

EP-A-0189896 discloses a method for leading together two imbricated flows, with which a first and a second imbricated flow are conveyed in two transport planes lying above one another. The distance of the leading edges (imbricated distance) is then increased to such an extent without a change in the orientation of the products, that singularised, lying products are present, i.e. the distance is larger than the length of the products measured in the conveyor direction. These are combined into a running-out formation, which consists of individual products or sets of in each case two products lying on one another, said products or sets of products being conveyed one after the other. Alternatively, again an imbricated formation of alternately deposited individual products from the first and second imbricated flow is formed after the singularisation. A singularisation step, as is necessary here, may in practise however only be carried out with low conveyor outputs, since the products must be greatly accelerated in the conveyor direction. With the conveyor outputs and conveyor speeds which are usual today, at present there are no suitable devices, e.g. gripper conveyors with a corresponding conveyor capacity. On the other hand, one wishes to make do without such an acceleration of the products, in order not to subject the products to high loads.

WO 88/00919 discloses a device for leading together two imbricated flows into a common imbricated flow by way of a rotating drum with a plurality of conveyor compartments. The bases of the conveyor compartments lie on a cylinder surface with a radius which is smaller than the radius of the drum. They are tilted with respect to the radial direction, so that the products may be inserted in a lying manner. In each case, one product of the two imbricated flows is introduced in an alternating manner with an offset in the axial direction, into a conveyor compartment in each case. The conveyor compartment, thus, has a small opening angle, so that it may receive only one product in each case. The conveyor compartments in each case have a pusher, which is arranged laterally, and specifically to the left and right of the introduced products in an alternating manner, and is movable in the axial direction. The products are centered by way of movement of the pushers. They are then fed into a running-out, common imbricated formation. The processing capacity of this drum is defined by the number of conveyor compartments and their maximal speed. For processing high conveyor outputs, the drums must be equipped with a high number of conveyor compartments, which entails corresponding spatial dimensions.

A device for leading together two flows of products held by grippers is disclosed in EP-A 0 399 188. Here, the products are held by a gripper in a hanging manner and conveyed along two conveyor paths, wherein the held product edge is orientated transversely to the conveyor direction. The distances of the conveyor paths reduce in a continuous manner in a first region, wherein the conveyor paths run parallel to one another in a second region. The product flows are unified in the manner of a zip closure into a common product flow, by way of the grippers of the one conveyor path having an offset in the conveyor direction to the grippers of the other conveyor path. In each case, one product of the first product flow thereby pivots in each case between two products of the second product flow, wherein the corresponding surface normals have a continuously reducing angle to one another in the first region, and are parallel to one another in the unified product flow. Optionally, a receiving by the grippers of a further gripper conveyor may be effected in the second region. The movement path of the grippers and their distance must be matched to the product width, since the products have a certain extension in the transverse direction. In particular, correspondingly large distances between the grippers are necessary with wide products, in order not to inhibit the described pivot movement. Hints with regard to the processing of imbricated flows are not to be found.

It is therefore the object of the invention, to specify a method for leading together imbricated flows, and a device for carrying out the method, which avoid the mentioned disadvantages and are particularly suitable with high conveyor outputs, and which may be carried out in a simple manner.

### BRIEF SUMMARY OF THE INVENTION

The method according to the invention assumes that flat products are conveyed in two imbricated flows which are spatially separated from one another, i.e. in a compact formation with a certain overlap of the products. Since the products normally lie in an imbricated formation, the surface normals as a rule are orientated essentially vertically, and thus, essentially perpendicularly to the conveyor direction. The flows are received by an intermediate conveyor and are conveyed further as a first or second product flow. Thereby, space intervals are created between individual products or at least between groups of products, which are conveyed directly overlapping one another in the initial formation. Space interval is to be understood in that in each case two products are distanced to one another, so that at least one front surface or rear surface of a product is preferably essentially completely exposed. In each case, one or more products of the respective other product flow may be introduced in a gentle manner into these space intervals without rubbing on one another. In order to avoid a space-consuming and mechanically burdening pulling-apart of the products in the plane of the products, the orientation of the products, at least of one of the product flows, is changed such that its surface normals point essentially in the horizontal direction directly before the unification of the product flows. This orientation change may be effected without a great effort by way of using gravitational force. A spatially compact formation with space intervals arises without having to significantly accelerate the products in the conveyor direction. The products of at least one of the product flows are then inserted with an essentially horizontal orientation of their surface normals or in a hanging or standing position, into the space intervals within the other product flow.

According to a preferred further formation of the invention, the products in the two product flows to be led together, at least during the unification of the product flows, have essentially the same orientation, i.e. their surface normals and edges corresponding to one another in each case point in the same direction. Only a parallel displacement takes place relative to one another, in order to unify the product or product groups into a common product flow. The products are preferably conveyed by way of grippers or other conveyor means, which move the products individually or in groups. In contrast to EP-A 0 399 188, with the invention, a space interval which is somewhat larger than the thickness of the product is sufficient in principle. The edge length of the products has no influence on the magnitude of the space interval.

Alternatively, a smaller angle may be enclosed between the surface normals of the products of the two product flows, which preferably lies between 0 and 450 and does not essentially change during the unification. Only when the product flows largely overlap one another are the orientations of the products adapted to one another.

With the unification of the product flows, the product flows are led together such that the space region which is covered by the products of the first product flow at least partly coincides with the space region covered by the products of the second product flow, preferably in a complete manner. The distance of the product flows is the distance of two points corresponding to one another, within these space regions, e.g. the corners which lie at the top and at the right in the conveyor direction. This distance is preferably reduced to zero.

Starting from an imbricated formation with a constant imbricated distance, the space intervals described above are preferably introduced by way of a product edge being gripped by a gripper or introduced into a pocket, and the product then conveyed in a hanging or uprightly standing manner. Depending on the orientation of the grippers or pockets, flexible products may also be bent on account of the gravity. The free end may then be supported by a rest, and the products may also be bent by way of this. With such a bending of the products, the bent parts are preferably not taken into consideration for determining the direction of the surface normals. The described movements of the products are caused by way of a suitable movement of the conveyor means holding them.

Also, several products may be gripped by a gripper in groups or transferred into a pocket, and the space interval in this case is located between the groups.

As an alternative, the space intervals may be produced by way of the products being introduced into conveyor compartments of a rotatable conveyor drum individually or preferably in groups. They are introduced from above, preferably on account of gravity, with a horizontal alignment of their surface normals. After depositing in the conveyor compartment, the surface normal of the products points in the direction of the surface normal of the support surface of the conveyor compartments, whose direction preferably corresponds to the conveyor direction. A conveyor compartment in each case receives products from the first and second imbricated flow. These are fed at different axial positions and are pushed onto one another in the axial direction by way of an additional pusher means or by way of gravity. If the axial displacement of the products from the first product flow is effected before the feeding of the products from the second product flow, then a particularly gentle treatment of the products is effected, since one avoids the products rubbing over one another.

The common product flow consists of products or groups of products from the first or second imbricated flow, which alternate with one another. It is possible, for example, to arrange the products one after the other individually (1:1) or in equally large groups (2:2, 3:3, . . . n:n) or also in differently large groups (1:2, 1:3, . . . , 1:n, 2:3, 2:4, . . . , m:n). The products which are originally conveyed in separate imbricated flows may thus be processed further in an infinite sequence. On conveying in groups, a significant increase in capacity is achieved by way of the multiple use of the intermediate conveyor. The original imbricated flow may likewise consist of stacks of products which lie on one another in an imbricated manner, and/or of complexly constructed products.

The inventive device for carrying out the method includes conveyor means which are capable of receiving the products from the first and the second imbricated flow and conveying them into a first product flow or into a second product flow. Such conveyor means are for example grippers, pockets or also conveyor compartments of a conveyor drum. The products are conveyed such that the space intervals described above are created at least for a short time. Furthermore, means for displacing the products of the first product flow are present, which move these relative to one another in a plane running essentially perpendicularly to the surface normals, into the space intervals within the second product flow. By way of this, the distance of the product flows is also reduced and finally a common product flow consisting of products from the first and the second imbricated flow are formed. These means may, for example, be realised by way of conveyer paths of the grippers or pockets, which approach one another. With a conveyor compartment which receives products from the first or second imbricated flow at different axial positions, these means may be realised by way of a pusher acting in the axial direction. Alternatively or additionally, the gravitational force may also be utilised, e.g. by way of the products sliding from above into pockets, grippers or conveyor compartments, in which products are already located.

A compact feed which is different to the imbricated formation is likewise conceivable, e.g. in stacks.

The invention permits a gentle, space-saving unification of two product flows, and, given an equal conveying of several products, permits the achievement of a significant increase in the capacity. For this, to some degree conveyor devices known per se are applied in a new manner. For this reason, the invention may be realised without any great design effort.

### BRIEF DESCRIPTION OF THE DRAWINGS

Examples of the invention are represented in the drawings and are described hereinafter. In a purely schematic manner there are shown in:

FIG. 1 a principle sketch of the method according to the invention, on unifying product flows consisting of simple products;

FIG. 2 a principle sketch of the method according to the invention, on unifying product flows consisting of product pairs;

FIG. 3 a principle sketch of the method according to the invention, on unifying imbricated flows, in which products folded into one another are conveyed;

FIG. 4 a principle sketch of the method according to FIG. 3, wherein the products are grouped together into product pairs;

FIGS. 5-7 different views of a first variant of a device for carrying out the method with a gripper conveyor, which comprises two sets of grippers which are arranged next to one another;

FIGS. 8, 9 a second variant of a device for carrying out the method, with two gripper conveyors which are arranged over one another, in a view from the side and from above respectively;

FIG. 10 the execution of the method according to the invention with a conveyor drum;

FIG. 11 the conveyor drum from FIG. 10, on processing a single imbricated flow;

FIG. 12 an application of the method according to the invention, for the flexible processing of products which have been put together in a collation stitching drum.

### DETAILED DESCRIPTION OF THE INVENTION

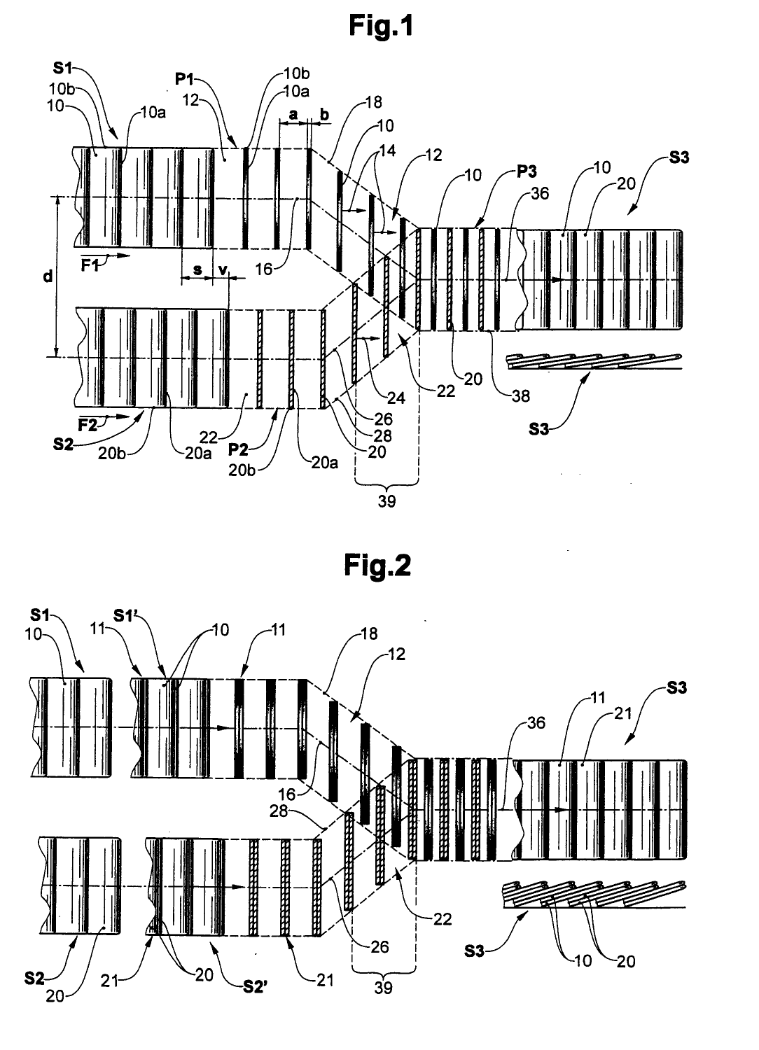

FIG. 1 shows a principle sketch of the method according to the invention, for unifying two imbricated flows S1, S2 into a common product flow P3. Represented is a plan view of the imbricated flows or product flows. The imbricated flows S1, S2 consist in each case of products 10, 20 which are arranged in a lying manner and overlapping one another with an imbricated distance s. The products 10, 20 may be identical or different. Here, it is the case of folded products 10, 20, e.g. newspapers or magazines.

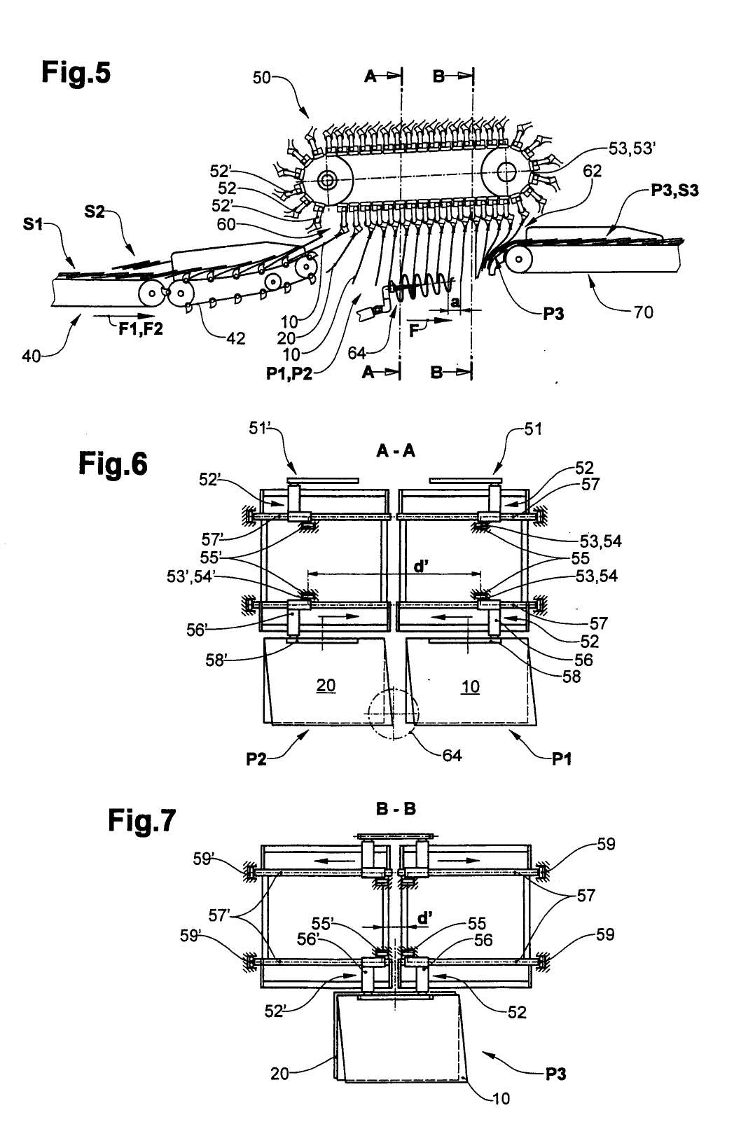

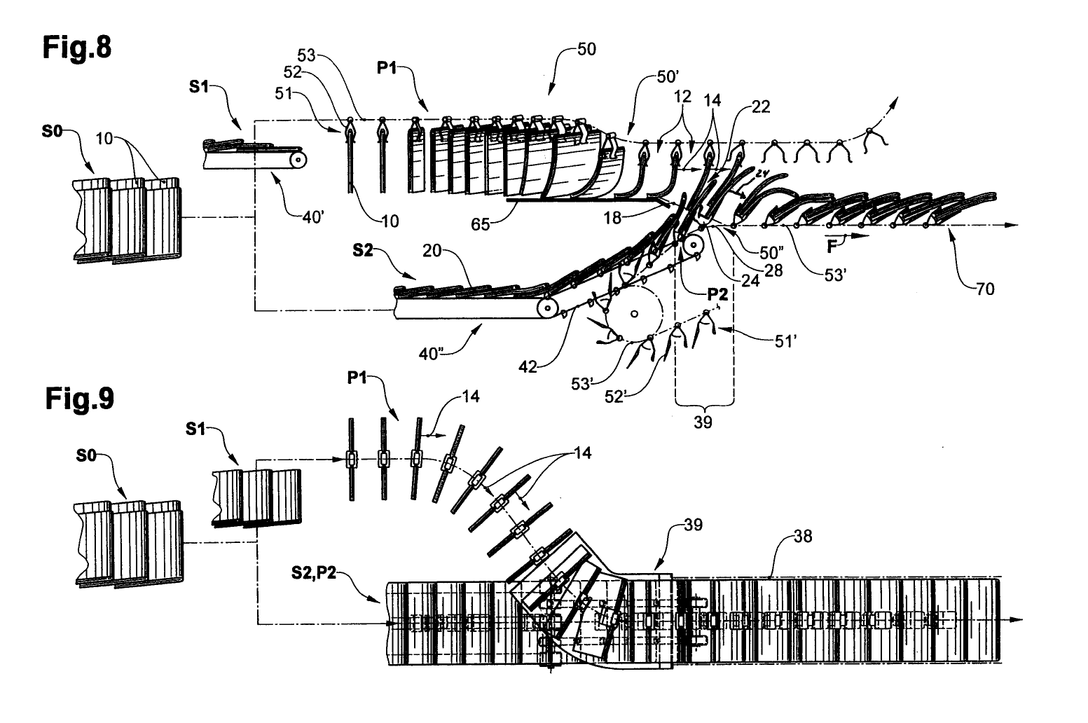

The imbricated flows S1, S2 are firstly converted into product flows P1, P2 of singularised products 10, 20. For this, the products 10, 20 for example, are received individually by way of grippers of an intermediate conveyor (cf. FIG. 5-8) The products 10, 20 are brought into a hanging position, and the surface normals 10, 24 point in the horizontal direction and the leading edges or side edges 10a, 20a, and 10b, 20b respectively in the horizontal or vertical direction. The product flows P1, P2 here are arranged next to one another in the same horizontal plane. They may, however, also be located above one another (cf, e.g. FIG. 8), and in this case the middle region of FIG. 1 may also be seen as a section in a vertical plane. The grippers in both cases may, for example, engage on the leading edge 10a, 20a, on the trailing edge (not shown) or on a side edge 10b, 20b.

The products 10, 20 are conveyed along movement paths 16, 26 which are firstly distanced to one another, and after unification are conveyed along a common movement path 36. The distance d between the movement paths 16, 26 thus reduces to zero. The movement path of a point which is fixedly assigned to a product 10, 20 may be seen as a movement path of the product, e.g. its centre of gravity or an edge centre. The movement path may correspond to the conveyor path of a gripper or run parallel thereto.

The spatial region 18, 28, 38 which is covered by the products 10, 20 or the product flows P1, P2, P3 or its lateral limitation is represented in a dashed manner. The unification region 39 begins where the overlap of the product flows P1, P2 begins, and ends on reaching a maximum overlap. In this region, the surface normals 14, 24 of the products 10, 20 are parallel to one another (as also in the remaining regions). The orientation of the products 10, 20 in space is not changed, i.e. no rotation about the surface normals 14, 24 takes place and the orientation of all edges 10a, 10b, 20a, 20b remain equal on unification.

The imbricated flows S1, S2 are conveyed with the same speed and with an offset v seen in the conveyor direction F1, F2, which corresponds to roughly half the imbricated distance s. By way of this, one ensures that the products 10, 20 have the correct phase shift on unifying the imbricated flows. Alternatively, one of the movement paths 16, 26 may be longer than the other one by a suitable amount. It is to be understood that the movements of the products 10, 20 may also be synchronised in another manner.

Space intervals 12, 22 between the products are formed by way of straightening up the product 10, 20. The distance a of the products 10, 20 in the product flow P1, P2 or the width of the space intervals 12, 22 here corresponds roughly to the imbricated distance s, but may however also differ from it with different conveyor speeds, and it is preferably smaller or equal to the imbricated distances. The width a of the space intervals 12, 22 is larger than the thickness b of the products 10, 20, but may be significantly smaller than the length of the side edges 10b, 20.

For unifying the product flows P1, P2, these are led together such that in each case one product 10 of the first product flow P1 moves into a corresponding space interval 22 in the second product flow P2. According to the invention, this is effected in a particularly space-saving manner, by way of the surface normals 14, 24 of the products 10, 20 having the same orientation, thus the products 10, 20 being aligned parallel to one another. They do not change their orientation in space. By way of a movement parallel to the product surface, the product flows P1, P2 may therefore be moved into one another in a comb-like manner. The space interval 12, 22 for this must only be slightly wider than the product width b.

After unification, the common product flow P3 which still consists of isolated products 10, 20 may optionally be converted again into an imbricated flow S3, e.g. by way of depositing onto a conveyor belt.

FIG. 2 shows a modification of the method of FIG. 1. Hereby, the original imbricated flow S1, S2 is converted into an imbricated flow S1′, S2′ with which in each case two products 10, 20 lie on one another in a congruent manner or with a small offset, and form product pairs. The product pairs 11, 21, as the individual products 10, 20 in FIG. 1, are gripped by grippers and are straightened up for forming space intervals 12, 22. The product flows P1, P2 are moved into one another in a comb-like manner as with FIG. 1. The common product flow P3 may be converted again into an imbricated formation S3, which consist of pairs of products 10, 20 which lie over one another in a congruent manner or slightly offset.

Also more than two products may be grouped into a group. The space intervals are then located between the groups. Due to this measure, the conveying capacity of a conveyor applied for conveying and that of the intermediate conveyor may be doubled or quadrupled or the conveyor speed lowered accordingly.

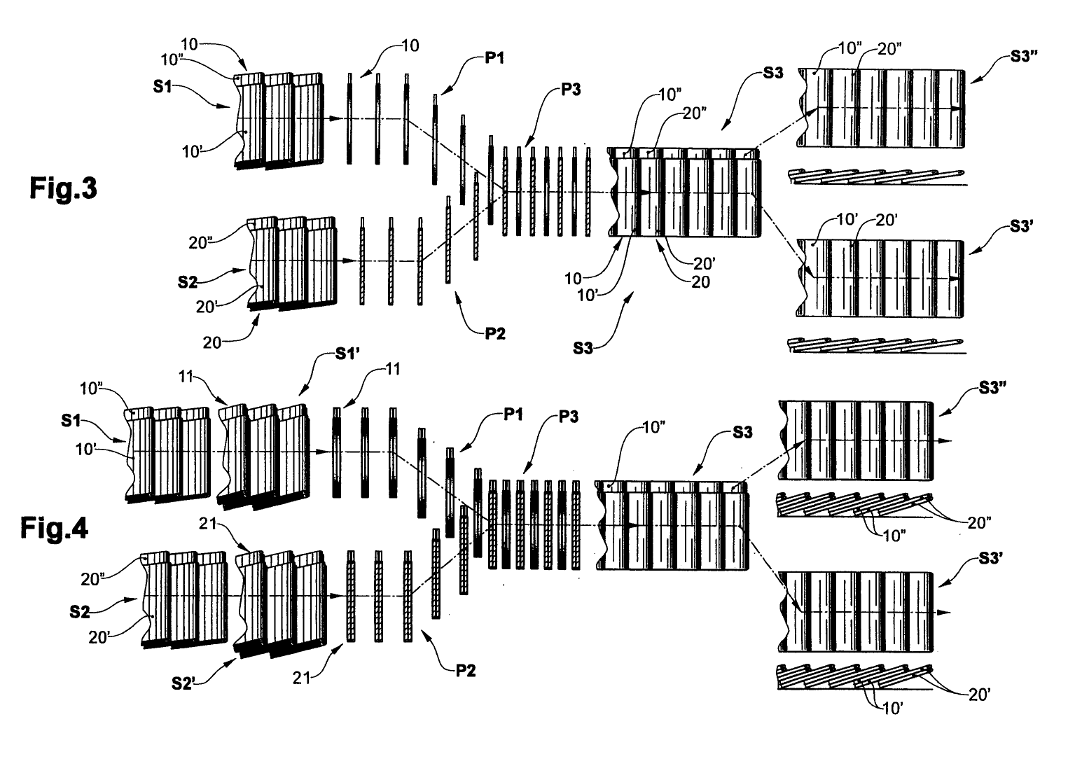

FIG. 3 likewise shows a modification of the method of FIG. 1, with which, instead of simple products, it is those products 10, 20 which consist of two products 10′, 10″, 20′, 20″ which are folded into one another, which are conveyed. The products 10′, 10″, 20′, 20″ may be identical or also different. The running-in imbricated formations S1, S2 originate for example from a rotation printing machine which feeds such products folded into one another. The handling of these products up to the production of the common product flow P3 or the imbricated formation S3 produced therefrom corresponds to FIG. 1. As schematically indicated here, one may add a step, with which the imbricated flow S3 is separated into two part imbricated flows S3′, S3″. Such a separating step may be designed as, for example, described in DE-A 2417614, CH 634 530 or EP-A 0 936 169.

The method shown in FIG. 4 corresponds to that of FIG. 2 with the difference that the products 10, 20 consist of two products 10′, 10″, 20′, 20″ folded into one another, as in FIG. 3. Two part imbricated flows S3′, S3″ are produced after separating up the common product flow P3 or the imbricated formation S3 formed therefrom, and these part imbricated flows in each case comprise pairs of products 10′, 20′ or 10″, 20″ which lie congruently over one another.

FIG. 5 shows a device for carrying out the method, in a lateral view. FIGS. 6 and 7 schematically show sections along the lines A-A and B-B.

The device comprises a feed conveyor device 40, an intermediate conveyor 50 and a conveying-away device 70. The feed conveyor device and the conveying-away device 40, 70 here are designed as belt conveyors, on whose conveyor belts the products 10, 20 are transported in an imbricated formation S1, S2, S3. The feed conveyor device 40 comprises two belt conveyors, of which in the present representation only one is visible. Additionally, in each case a cycle conveyor 42 is present connecting to each belt conveyor and this cycle conveyor sets a constant product distance and may compensate irregularities in the running-in imbricated formation S1, S2.

The intermediate conveyor 50 is designed as a gripper conveyor with a plurality of grippers 52, 52′ and receives the products 190, 20 in a receiver region 60, from the feed conveyor device 40/42. As the views perpendicular to the conveyor direction F of the gripper conveyor in FIGS. 6 and 7 show, a first group 51 of grippers 52 is distanced in the horizontal direction to a second group 51′ of grippers 52′. In each case, the gripers 52, 52′ of a group 51, 51′ are moved along a common conveyor path 53, 53′. The conveyor path 53, 53′ is the movement path of any point of a gripper 52, 52′ and here of one of its guide elements 54, 54′ by way of example. The conveyor paths 53, 53′ therefore have a distance d′ to one another transverse to the conveyor direction F. In the lateral view in FIG. 5, the conveyor paths 53, 53′ coincide. The distance d′ of the groups 51, 51′ of grippers 52, 52′ is set in dependence on their position along the conveyor paths 53, 53 by way of a suitable cam guide 55, 55′, which cooperates with the guide elements 54, 54′.

As FIG. 5 shows, the grippers 52 of the first group 51 are additionally offset in the conveyor direction F of the gripper conveyor at each point of their conveyor path 55 by the amount a relative to the grippers 52′ of the second group 51′. The arrangement of the products 10, 20 corresponds to FIG. 1.

The distance d′ is selected such that the products 10, 20 gripped by the different groups 51, 51′ of grippers 52, 52′, when being received by the grippers 52, 52′ from the feed conveyor device 40/42, do not overlap one another in a projection in the conveyor direction F. This situation is represented in FIG. 6. Here, the products 10, 20 are located next to one another and the respective product flows P1, P2 do not overlap.

The distance d′ is reduced by the cam guide 55, 55′ in the course of the forward movement of the grippers 52, 52′. The product flows P1, P2 are pushed into one another in a comb-like manner by way of this. Now a product 10 held by a gripper 52 of the first group 51, seen in the conveyor direction F, is located directly in front of or behind a product 20 held by a gripper 52′ of the second group 51′, in the view according to FIG. 7.

The products 10, 20 are subsequently deposited on the conveyor belt of the conveying-away device 70 at a transfer location 62.

The intermediate conveyors 50 are hereinafter described in a more detailed manner. The two groups 51, 51′ of grippers 52, 52′ and their guide and drive devices are designed in a mirror-symmetrical manner with respect to a vertical plane. The grippers 52, 52′ consist of a base body 56, 56′ which is arranged on an elongate guide rod 57, 57′, and is displaceable along this. The grippers 52, 52′ further comprise a gripper jaw 58, 58′. This keeps the products 10, 20 on an edge running parallel to the guide rod 57, 57′ and, in principle, the products may however also be held on an edge running perpendicularly thereto. The gripper jaw 58, 58′ is arranged projecting with respect to the base body 56, 56′, i.e. in a non-symmetrical manner, and in FIGS. 6 and 7 the gripper jaws 58 of the group arranged on the right project to the left and vice versa. With this, the products 10, 20 may be gripped centrally on an edge and, seen in the conveyor direction F, may be brought to overlap without the conveyor paths 53, 53′ of the grippers 52, 52′ crossing or overlapping. It is also conceivable for individually movable grippers to be led together into a common conveyor path.

The guide rods 57, 57′ are aligned in a horizontal manner. They are guided in a lateral guide 59, 59′, e.g. a guide groove in a vertically orientated plate. The guide rods 57, 57′ run along an elliptical movement path, and this movement, with the exception of the transverse displacement, also corresponds to the movement of the grippers 52, 52′. The guide rods 57, 57′ are driven, for example, by way of a movement element, which is not shown here, e.g. a pull element.

The grippers 52, 52′ by way of cam guides which are likewise not represented here, are closed at the receiver location 60 and opened again at the transfer location 62. They are transported in an empty manner via the upper part of the conveyor path 53, 53′ back again to the receiver location 60.

In order to prevent the products 10, 20 from fanning out at their free ends, a spiral or helical conveyor 64 is arranged below the intermediate conveyor.

FIGS. 8 and 9 show a further device for carrying out the method according to the invention, in a view from the side (FIG. 8) or from above (FIG. 9). It comprises an intermediate conveyor 50, which contains two gripper conveyors 50′, 50″ which are independent from one another. These convey a first and second group 51, 51′ of grippers 52, 52′ along a first or second conveyor path 53, 53′ respectively. The conveyors paths 53, 53′ are located above one another. In a plan view, the conveyor paths 53, 53′ in a first section run next to one another with a reducing distance, and in a second section in the same vertical plane. The spatial regions 18, 28 covered by the product flows P1, P2 are therefore firstly horizontally and vertically distanced to one another. That region in which its overlap begins, is the unification region 39.

The upper gripper conveyor 50′ grips products 10 originating from a first imbricated flow S1 at their upper edge and conveys these in a hanging manner or regionally also with their free ends supported by a rest 65. The lower gripper conveyor 50″ grips products originating from a second imbricated flow S2 at their lower edge and conveys these in an essentially standing position which here is inclined slightly in the conveyor direction F. The gripper conveyors 50′, 50″ approach one another in the horizontal as well as the vertical direction, in front of the unification region 39. In front of the unification region 39, the surface normals 14 of the upper products 10 are aligned in an essential horizontal manner. Space intervals 22 are formed between the lower products 20 by way of gripping the products 20 by the lower grippers 52′. The upper products 10 may be introduced into these. After their free end has been brought into such space intervals 22, the products 10, 20 are moved relative to one another in the vertical direction. This on the one hand is effected by way of the conveyor path 52′ of the lower gripper conveyor 50″ being directed obliquely upwards, and the other hand by way of the upper products 10 being let go of by the grippers 52 assigned to them and sliding into the lower grippers 52′ due to gravity. The lower grippers 52′, thus, convey two products 10, 20 and as a common product flow P3.

A distance change of the conveyor paths 53, 53′ of the gripper conveyors 50, 50′ is required per se for unifying the product flows P1, P2, and this change corresponds roughly to a product width. Here, this size is reduced by way of the rest 65 deflecting the free edges of the upper products 10, and thus, shortening the effective product width. Surface normals in the sense described above are those of the product part which is not bent.

Even with this example, the grippers instead of engaging on the upper or lower edge may engage on a side edge, in order to execute the described movements.

Instead of a gripper conveyor 50″, a pocket conveyor with pockets which support the products 10, 20 from below may also be applied instead of a gripper conveyor 50″. The support walls of the pockets may be directed vertically, similarly to the clamping elements of the gripper 52 here, or may also be inclined out of the vertical.

The products 10, 20 are fed, for example, in an imbricated formation S0 consisting of products 10, 20 folded into one another. This formation S0, with means not shown here, is divided up into two simple imbricated flows S1, S2 and conveyed by way of feed conveyor devices 40′, 40″. The products 10 of the imbricated flow S1 are received by the upper grippers 52. The other imbricated flow S2 is still conveyed further until shortly before the unification region 39. Its products 20 then, here after an additional alignment or cycling by way of a cycle conveyor 42, are received by a lower gripper conveyor 50″ and conveyed further as a common product flow P3. Subsequently, the products 10, 20 are deposited onto a conveyor belt or processed in another manner.

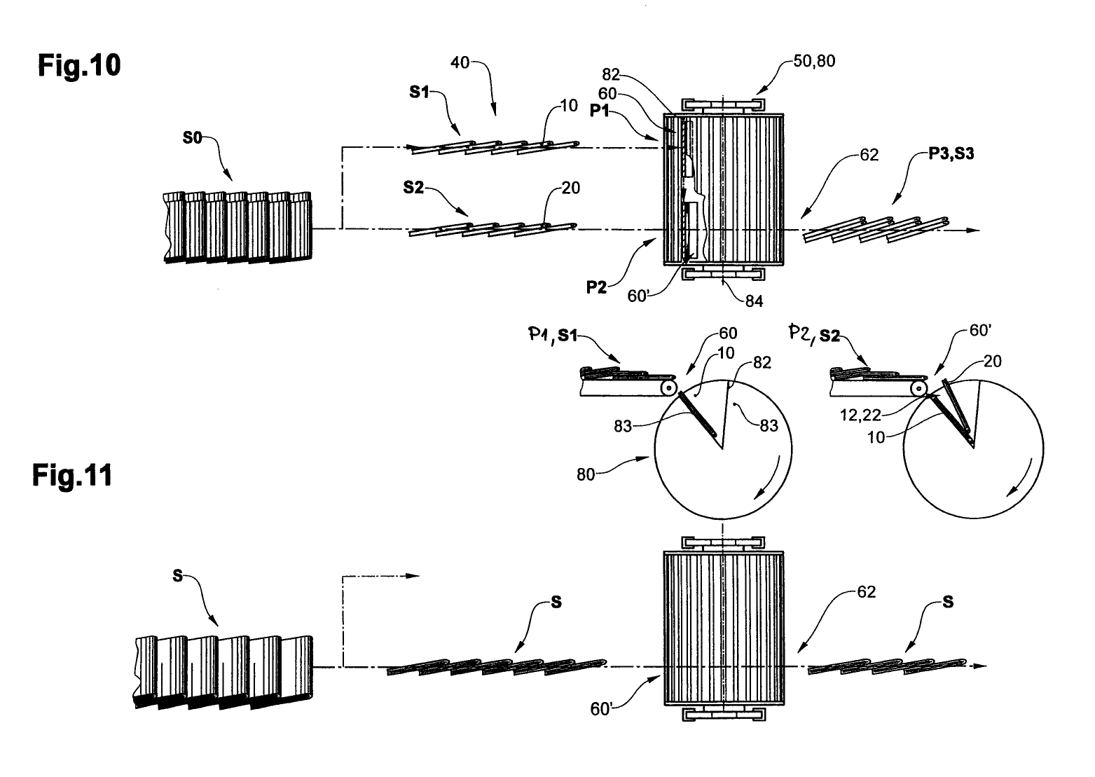

FIG. 10 shows a further device for carrying out the method according to the invention with a conveyor drum 80 known per se as an intermediate conveyor 50, in a view from above. The conveyor drum 80 which is rotatable about its longitudinal axis 84 comprises a multitude of conveyor compartments 82, which open in the radial direction and have radially aligned support walls 83. With a feed conveyor device 40 comprising two conveyor belts, products 10, 20 are conveyed in an imbricated formation S1, S2 to two receiver locations 60, 60′. These lie distanced to one another in the axial as well as radial direction above the conveyor drum 80. First products 10 are fed individually or in their multiple at the first receiver location 60. During the rotation of the drum, these are displaced in the axial direction with suitable displacement means, so that they assume roughly the axial position of the second receiver location 60′. This displacement is effected before the conveyor compartment 82 reaches the second receiver location 60′ and the second products 20 are fed. The second products 20 are therefore introduced from above into the conveyor compartments 82 which are already filled with the first products 10. Rubbing of the products on one another is largely avoided. Their relative movement on feeding the second products 20 is in the product plane or the vertical direction. The first products may likewise be straightened up or slightly inclined with respect to this, when they are supported on the support wall 83. A space interval 12, 22 in the product flow P1, P2 exists, since the individual products 10, 20 or groups thereof are separated out of the fed imbricated formation S1, S2 and are introduced into the conveyor compartments 82. The products are deposited in a common product flow P3 at the transfer location 62.

As with FIGS. 8 and 9, the running-in imbricated formations S1, S2 may originate from an imbricated formation 50 of products folded into one another.

Instead of imbricated formations S1, S2, the products may also be fed in another arrangement, e.g. in the form of stacks, or individually.

FIG. 11 shows the case with which only one imbricated formation S is to be transported instead of two imbricated formations S1, S2. In this case, the conveyor drum may be bridged. As alternatives, the products may be brought into the conveyor compartments 82 at a receiver location 60′ and be deposited again downstream at the transfer location 62. This case e.g. occurs when products with high page numbers are to be manufactured from the rotation.

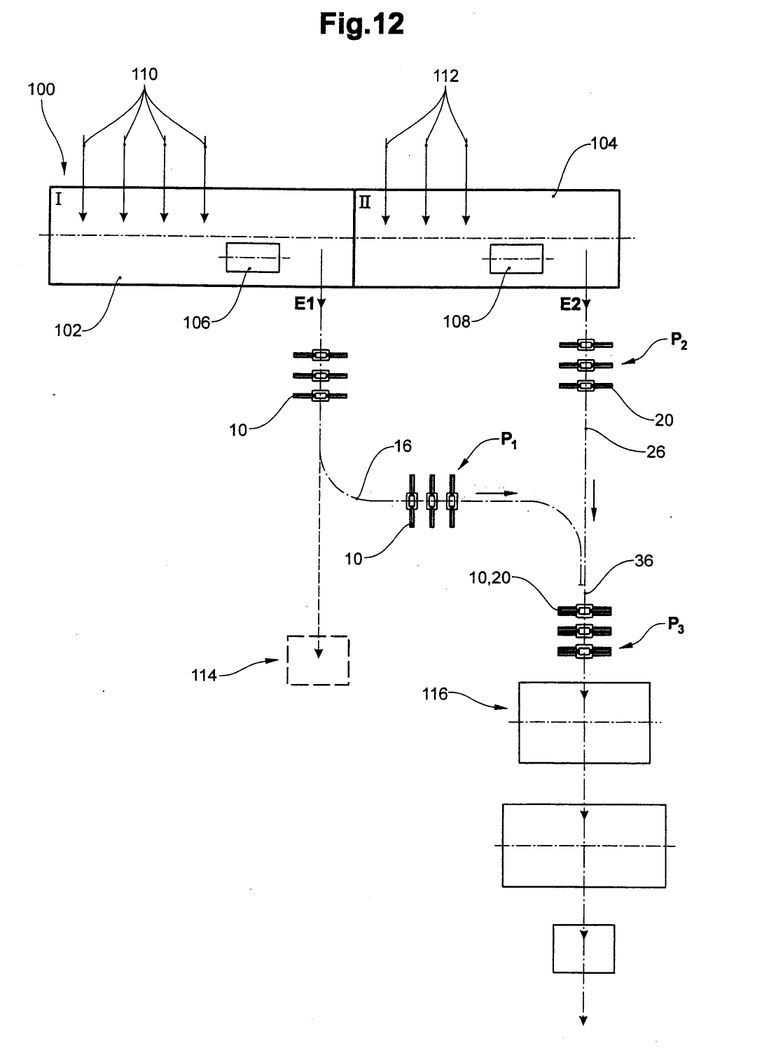

FIG. 12 shows an example for the application of the method according to the invention in combination with the manufacture of products 10, 20 with a collation stitching drum 100. Such collation stitching drums are known per se, e.g. from EP-A 0 341 425 or EP-A 0 550 828. They are particularly applied with the production of magazines, in order to put together a total product out of individual product parts. The product parts, e.g. individual printed sheets and/or attachments, are thereby fed at several feed stations 110, 112 which are arranged offset in the axial direction, to the collation stitching drum 100, transported in the axial direction and are removed again in a removal region optionally after the stitching. Here, the collation stitching drum 100 consist of two modules 102, 104 which are coupled to one another. Each module 102, 104 is constructed essentially equally and comprises feed stations 110 and 112, stitching modules 106 and 108 and removal regions E1 and E2.

The products 10, 20 which are manufactured in each case in one of the modules are removed in a first mode at the removal regions E1, E2, led to further processing stations 114, 116 and in each case processed further independently of one another. The products 10, 20 manufactured in the modules 102, 104 may be identical or different from one another.

For some applications, it may be desirable to manufacture an assembled end product which comprises more product parts than may be processed with an individual module 102, 104. For this reason, in a second mode, the product flows P1, P2 which arise at the removal regions E1, E2 of the two modules 102, 104, are led together with the help of the method according to the invention or with a device according to the invention, along the conveyor paths into a product flow P3 which is moved together along a common conveyor path 26. The products 10, 20 manufactured in the modules 102, 104 are in this case preferably equal. The common product flow P3 manufactured according to the invention consists of pairs of products 10, 20. These are then led to the further processing station 116 whilst the other further processing station 114 is inactive.

Here, the product flows P1, P2 which arise at the removal regions E1, E2 of the two modules 102, 104 are schematically shown as gripper flows, but here however imbricated flows may likewise arise, which subsequently are transferred into grippers or may be processed further as imbricated flows.

The shown arrangement has the advantage that depending on the demands, products 10, 20 which are independent of one another, with in each case n1 and n2 product parts respectively or more complex products with n1+n2 product parts, may be manufactured, wherein n1 and n2 corresponds to the number of feed stations 110, 112 respectively of the respective module. The flexibility of known processing devices is significantly increased by way of this. Of course, one may also apply several collation stitching drums which are independent of one another instead of a modularly constructed collation stitching drum.

1.-16. (canceled)

17. A method for unifying at least one first and a second imbricated flow of flat products, in particular printed products, into a common product flow consisting of products of the first or second imbricated flow, comprising the following steps:
conveying the flat products in the first imbricated flow and in the second imbricated flow, wherein the imbricated flows are initially arranged at a distance with respect to one another;
transferring the products from the first and second imbricated flow to an intermediate conveyor;
conveying the products by the intermediate conveyor in a first product flow and in a second product flow respectively;
forming the common product flow by successively reducing a distance of the product flows during the conveying step, so that the product flows at least approximately move through the same spatial region;
wherein the step of forming the common product flow further comprises:
creating space intervals between individual products or between groups of products within the first and second product flow respectively;
arranging the products of at least of one of the product flows with an essentially horizontal orientation of their surface normals;
inserting the products with an essentially horizontal orientation of their surface normals into the space intervals within the other product flow, in order to create the common product flow.

18. A method according to claim 17, further comprising a step of conveying the products with a constant alignment of their edges and their surface normals in space at least during the step of forming the common product flow.

19. A method according to claim 18, further comprising a step of conveying the products of both product flows aligned to one another in a manner such that edges corresponding to one another and their surface normals run parallel to one another, and displacing the products relative to one another perpendicularly to their surface normals at least during the step of forming the common product flow.

20. A method according to claim 17, further comprising the steps of:
providing an intermediate conveyor which comprises two groups of first and second conveyor elements respectively, in particular grippers, and moving the first and second conveyor elements along a first and second conveyor path respectively;
transferring the products from the first and second imbricated flow to the first and second conveyor elements respectively;
forming the common product flow by way of a relative movement of the first and second conveyor elements respectively;
conveying further the products in the common product flow by the first and/or second conveyor elements.

21. A method according to claim 20, further comprising a step of holding the products of at least of one of the product flows at their edge which leads or trails in the imbricated formation, and conveying the products in a hanging and/or standing manner at least directly before the step of forming the common product flow.

22. A method according to claim 17, wherein the first conveyor path, after a region where the product flows are unified, runs parallel to the second conveyor path and at a distance thereto in the horizontal direction.

23. A method according to claim 17, wherein the first conveyor path, at least during the unification of the product flows, runs parallel to the second conveyor path and distanced thereto in the vertical direction.

24. A method according to claim 17, further comprising the steps of:
providing, as the intermediate conveyor, a conveyor drum rotatable about an axis running in an axial direction and having a plurality of conveyor compartments opening in a radial direction;
transferring products from the first and second imbricated flow to a common conveyor compartment at transfer locations which are axially distanced to one another;
arranging the products in a common conveyor compartment;
displacing the products arranged in a common conveyor compartment during the rotation of the conveyor drum relative to one another in the axial direction, in a manner such that they overlap.

25. A method according to claim 17, wherein the common product flow comprises individual products, or groups of products, said products or groups of products being arranged in an alternating sequence and in each case originating from the first or the second imbricated flow.

26. A device for unifying at least one first and a second imbricated flow of flat products, in particular printed products, into a common product flow consisting of products of the first or second imbricated flow, comprising:
a first and a second conveyor for conveying the flat products in the first imbricated flow and in the second imbricated flow, wherein the first and second conveyors are arranged at a distance with respect to one another;
an intermediate conveyor with conveyor elements which are capable of receiving the products from the first and second conveyor and conveying them in a first product flow and in a second product flow respectively, in a manner such that space intervals are created within the first and second product flow respectively, and that a distance of the product flows is reduced by displacing the products at least of one of the product flows with an essentially horizontal orientation of their surface normals, into the space intervals within the other product flow, such that the product flows at least approximately move through the same spatial region and form a common product flow.

27. A device according to claim 26, wherein the intermediate conveyor comprises two groups of first and second conveyor elements respectively, said groups being independent of one another, and said conveyor elements being movable along a first and second conveyor path respectively, wherein the first and the second conveyor path have a distance to one another, which changes in the course of the conveyor paths.

28. A device according to claim 27, wherein the first and the second conveyor path are arranged distanced to one another in the horizontal direction.

29. A device according to claim 28, wherein the intermediate conveyor comprises a plurality of first and second guide rods, which are orientated parallel to one another and in each case are movable along a closed, first and second revolving path respectively, wherein the first and second revolving paths are orientated perpendicularly to the first and second guide rods and run parallel to one another and wherein the first and second conveyor elements are mounted in each case on a guide rod and are displaceable along this for changing the distance of the conveyor elements.

30. A device according to claim 27, wherein the first conveyor path is arranged above the second conveyor path in the vertical direction.

31. A device according to claim 30, wherein the second conveyor elements are capable of receiving the products conveyed by the first conveyor elements and of conveying the first and second products together.

32. A device according to claim 26, wherein the intermediate conveyor comprises a rotatable conveyor drum with a plurality of conveyor compartments which open in the radial direction and with displacement elements capable of displacing the products arranged in a common conveyor compartment, relative to one another in the axial direction during the rotation of the conveyor drum, in a manner such that they overlap one another.
